(19) United States
(12) Patent Application Publication
(10) Pub. No.: US 2022/0020205 A1
(43) Pub. Date: Jan. 20, 2022

(54) SYSTEM AND METHOD FOR INTERACTIVE VISUALISATION OF A PRE-DEFINED LOCATION

(71) Applicant: MARLABS INNOVATIONS PRIVATE LIMITED, BANGALORE (IN)

(72) Inventors: JOJITH THENGUNGAL RAJAN, KAKKANAD (IN); SHINEETH HAMZA, MANJERI (IN)

(73) Assignee: MARLABS INNOVATIONS PRIVATE LIMITED

(21) Appl. No.: 17/088,740

(22) Filed: Nov. 4, 2020

(30) Foreign Application Priority Data
Jul. 16, 2020 (IN) 202041030319

(51) Int. Cl. G06T 15/20; G06F 3/01; G06T 19/00

(52) U.S. Cl. CPC G06T 15/205; G06T 19/006; G06F 3/011

(57) ABSTRACT

System and method for interactive visualisation of a pre-defined location are provided. The system includes a multimedia retrieving module configured to retrieve one of a plurality of images, a plurality of videos, a plurality of multimedia visuals or a combination thereof from a database, a visualisation module configured to allow a user to experience a virtual view of one of a location, one or more entities within the pre-defined location, or a combination thereof within the pre-defined location using one of a virtual reality technique, an augmented reality technique or a mixed reality technique and a user interaction module configured to interact dynamically, by the user, with the virtual view of one of the location or the one or more entities within the pre-defined location or a combination thereof in real time via at least one user device to experience immersive interaction of the user within the pre-defined location.

### CROSS-REFERENCE TO RELATED APPLICATION

This Application claims priority from a complete patent application filed in India having Patent Application No. 202041030319, filed on Jul. 16, 2020 and titled “SYSTEM AND METHOD FOR INTERACTIVE VISUALISATION OF A PRE-DEFINED LOCATION”

### FIELD OF INVENTION

Embodiments of a present disclosure relate to visualisation of a location, and more particularly to a system and method for interactive visualisation of a pre-defined location using mixed reality technique.

### BACKGROUND

Visualisation is a process of representation of object, situation, or set of information as a chart or other images in a required format. One such visualisation is the visualisation of a given location. In a pandemic situation, where people are unable to physically location or a place, virtual visualisation plays a critical role. In a specific situation where students and parents are looking to make the right decision when it comes to college choice. To make such a decision, there are several variables which need to be considered. Understanding and experiencing campus life before joining would be a big help. Since the recent times, due to the COVID-19 pandemic which has made a huge impact across the globe, the situation has forced colleges and universities to shut down, due to which virtual visits such as those accomplished through mobile applications have taken on a more important role. Experiencing it digitally from the convenience of a mobile app would be even better. However, the virtual experience may not be dynamic, and the user may not be able to interact virtual objects present in the visualization.

Hence, there is a need for an improved interactive visualisation of a pre-defined location using mixed reality technique.

### BRIEF DESCRIPTION

In accordance with one embodiment of the disclosure, a system for interactive visualisation of a pre-defined location is disclosed. The system includes one or more image processors. The system also includes a multimedia retrieving module configured to retrieve one of a plurality of images, a plurality of videos, a plurality of multimedia visuals or a combination thereof from a database. The plurality of images, the plurality of videos and the plurality of multimedia visuals are captured by a plurality of image capturing devices, wherein each of the image capturing devices are positioned at a pre-fixed location within the pre-defined location. The system also includes a visualisation module configured allow a user to experience a virtual view of one of a location, one or more entities within the pre-defined location, or a combination thereof within the pre-defined location using one of a virtual reality technique, an augmented reality technique or a mixed reality technique. The virtual view is representative of the plurality of images, the plurality of videos or the plurality of multimedia visuals retrieved by the multimedia retrieving module. The system also includes a user interaction module configured to The system also includes a user interaction module configured to interact dynamically, by the user, with the virtual view of one of the location or the one or more entities within the pre-defined location or a combination thereof in real time via at least one user device to experience immersive interaction of the user within the pre-defined location.

In accordance with one embodiment of the disclosure, a method for interactive visualisation of a pre-defined location. The method includes retrieving one of a plurality of images, a plurality of videos, a plurality of multimedia visuals or a combination thereof from a database. The method also includes allowing a user to experience a virtual view of one of a location, one or more entities within the pre-defined location, or a combination thereof within the pre-defined location using one of a virtual reality technique, an augmented reality technique or a mixed reality technique. The method also includes interacting dynamically by the user, with the virtual view of one of the location, the one or more entities within the pre-defined location or a combination thereof in real time for experiencing immersive interaction of the user within the pre-defined location.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for interactive visualisation of a pre-defined location in accordance with an embodiment of the present disclosure;

FIG. 2 is a block diagram of an exemplary embodiment of the system for interactive visualisation of a college of FIG. I in accordance with an embodiment of the present disclosure;

FIG. 3 is a block diagram representation of a processing subsystem located on a local server or on a remote server in accordance with an embodiment of the present disclosure; and

FIG. 4 is a flow chart representing steps involved in a method for interactive visualisation of a pre-defined location in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . s” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and method for interactive visualisation of a pre-defined location. The term “interactive visualisation” may be defined as a virtual interaction which may enable a user to interact with a virtual environment within the pre-defined location. In one embodiments the pre-defined location may include one of an educational institution, a medical organisation, a house, a restaurant, a mall, a monument, a government institution or a private institution.

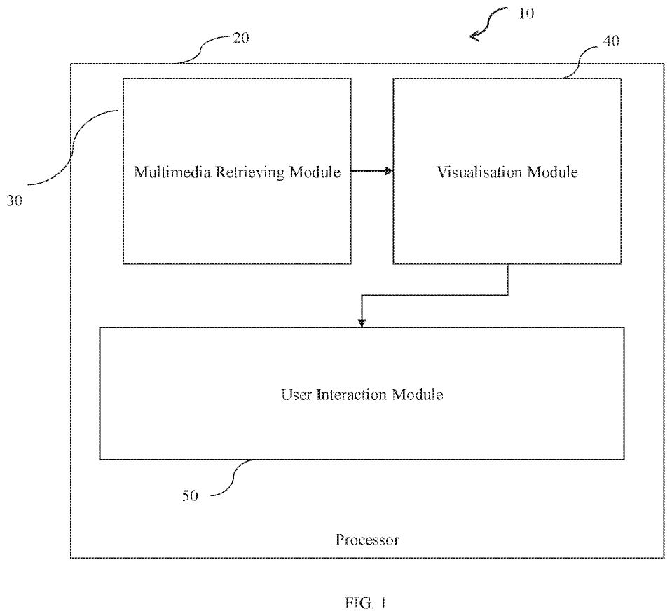

FIG. 1 is a block diagram of a system 10 for interactive visualisation of a pre-defined location in accordance with an embodiment of the present disclosure, the system 10 includes one or more processors 20. The system 20 also includes a multimedia retrieving module 30 operable by the one or more processors 20. The multimedia retrieving module 30 is configured to retrieve one of a plurality of images, a plurality of videos, a plurality of multimedia visuals or a combination thereof from a database. The plurality of images, the plurality of videos and the plurality of multimedia visuals are captured by a plurality of image capturing devices, wherein each of the image capturing devices are positioned at a pre-fixed location within the pre-defined location. In one embodiment, the plurality of image capturing devices may include at least one of a still camera, a video camera, a live camera, a 360 degree live camera or a combination thereof. The plurality of image capturing devices may be fixed at every required location within the pre-defined location. For example, a location may be a hospital, wherein the 360-degree live camera may be fixed in a patient's ward which may be configured to capture the live streaming of the patient's ward in all 360 degrees. This may help a caretaker of the patient to monitor the patient even when the caretaker is not physically present within the patient's ward.

In one exemplary embodiment, the plurality of images, the plurality of videos and the plurality of multimedia visuals are captured and stored in the database in real-time. In such embodiment, the streaming of the plurality of images, the plurality of videos and the plurality of multimedia visuals may be done in real time. More specifically, the real time streaming may be updated in the database in real time; such uploaded real time streaming may be retrieved by the multimedia retrieving module 30 from the database and may be viewed by the user on a user device in real time.

Furthermore, in another exemplary embodiment, the plurality of images, the plurality of videos and the plurality of multimedia visuals are captured and pre-stored in the database. In such embodiment, the data representative of one of the plurality of images, the plurality of videos and the plurality of multimedia visuals may be recorded and may be stored in the database at any instant of time. The date may be updated at every pre-defined amount of time, wherein the pre-defined amount of time may be defined as per the requirement of the user. In such embodiment, the user may retrieve the data associated with the pre-defined location from the database any time and may visualise the same via the user device anytime from any place.

The system 10 also includes a visualisation module 40 which is operatively coupled to the multimedia retrieving module 30. The visualisation module 40 is configured to allow a user to experience a virtual view of one of a location, one or more entities within the pre-defined location, or a combination thereof within the pre-defined location using one of a virtual reality technique, an augmented reality technique or a mixed reality technique. The virtual view is representative of the plurality of images, the plurality of videos or the plurality of multimedia visuals retrieved by the multimedia retrieving module 30. As used herein, the term “virtual reality (VR)” is defined as a simulated experience that can be similar to or completely different from the real world. Also, the term “augmented reality (AR)” is defined as is an interactive experience of a real-world environment where the objects that reside in the real world are enhanced by computer-generated perceptual information. Further, the term “mixed reality (MR)” is defined as a technique of merging of real and virtual worlds to produce new environments and visualizations, where physical and digital objects co-exist and interact in real time. Further, one of the plurality of images, the plurality of videos or the plurality of multimedia visuals are modified using a set of algorithms and a set of rules to represent the same in one of the AR, VR and the MR techniques which enables the user to view on the user device. In such embodiment, the user device may include one of a computing device, a virtual reality device, an augmented reality device, a mixed reality device or a combination thereof. In such embodiment_{;} the computing device may be one of a mobile phone, a tablet, a laptop, a smart TV, or the like. Further as used herein the term “virtual reality (VR) device” may be defined as a device which facilitates the experience of the VR technology for the user. In one embodiment, the VR device may include a VR head mounted device, a VR eye device, or the like.

Similarly, the term “augmented reality (AR) device” may be defined as a device which facilitates the experience of the AR technology for the user. In one embodiment, the AR device may include an AR head mounted device, an AR eye device, or the like. Also, the term “mixed reality (MR) device” may be defined as a device which facilitates the experience of the MR technology for the user. In one embodiment, the MR device may include a MR head mounted device, an MR eye device, or the like.

The system 10 further includes a user interaction module 50 operatively coupled to the visualisation module 40. The user interaction module 50 is configured to interact dynamically, by the user, with the virtual view of one of the location or the one or more entities within the pre-defined location or a combination thereof in real time via at least one user device to experience immersive interaction of the user within the pre-defined location. More specifically, the user interaction module 50 gives the user a privilege to interact virtually with the one or more entities located within the pre-defined location. In one exemplary embodiment, the one or more entities may be one or more objects, one or more people which may be located within the pre-defined location. The user may interact with the one or more entities as per the situation happening within the pre-defined location in real time. In such embodiment, the data associated with the one or more entities within the pre-defined location may be associated with the database which may include one of the plurality of images, the plurality of videos or the plurality of multimedia visuals retrieved by the multimedia retrieving module 30. Upon associating the data with the database, any interaction made with the one or more entities may be updated the database, here, the interaction may be a physical interaction within the pre-defined location or a virtual interaction via the system 10 on the computing device. In both the scenarios, the interaction would be reflected on the database by updating the database with the new set of one of a plurality of images, a plurality of videos or a plurality of multimedia visuals.

For example, a plurality of students may attend a virtual class by sitting at their corresponding houses but may enjoy the feel of a classroom through one of the VR, AR or the MR techniques. In such a situation, the user who is a student may interact with a teacher within the classroom which may give the feel of the real classroom comprising the teacher and a plurality of students exchanging information in real time, thereby enabling the dynamic interaction with the pre-defined location.

For another example, the pre-defined location being a hospital, the caretaker may be able to operate one or more biomedical instruments virtually by retrieving the captured data from the database and operating the corresponding one or more biomedical instruments such as an oxygen generator, oximeter, or the like upon analysing the data which was captured at different time intervals, thereby enabling static interaction with the pre-defined location.

In one exemplary embodiment, the system 10 may include a registration module (not shown in FIG. 1) which may be operatively coupled to the multimedia retrieving module 30 and may be operable by the one or more processors 20. The registration module may be configured to enable one or more users, one or more authorised entities and the like to register on a centralised platform in order to experience a virtual interaction. The centralised platform may be customised for a corresponding specific group of people or entities. In such embodiments, the entities may be an institution, an organisation or the like which may be associated with the pre-defined location.

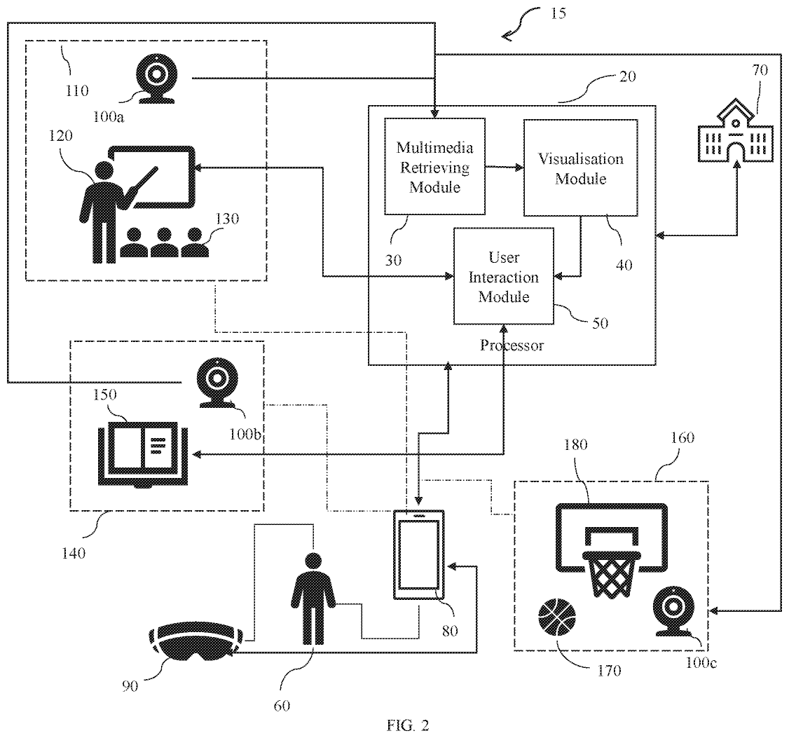

FIG. 2 is a block diagram of an exemplary embodiment of the system 15 for interactive visualisation of a college of FIG. 1 in accordance with an embodiment of the present disclosure. A student ‘S’ 60 wants to get an admission in a college ‘C’ 70. The College C is substantially similar to the pre-defined location of FIG. 1. Due to the pandemic happening across the globe, the student S 60 is unable to go and visit the college C 70 by person. Henceforth the student S 60 registers on a college platform via the registration module (not shown in FIG. 2) upon providing students details such as name, age, requirements, what is the student looking for?, the course, the year of joining, and the like. Prior to the student S 60 registration, the college C 70 may have the college platform customised by integrating a first database (not shown in FIG. 2) representative of college backup data with a second database (not shown in FIG. 2) representative of data for interactive visualisation of the college C 70 for the student S 60. Also, a plurality of 360 degree live cameras 100a are installed in every division or bifurcation within the college C 70, wherein the plurality of images, the plurality of videos and the plurality of multimedia visuals will be recorded and streamed into the second database of the college C 70 in real time.

Now the student S 60 has the access to visit any location within the college S virtually using a student device 80 which may be a smart device 80. The Student S 60 initially enters a classroom 110 virtually via the centralised platform and is able to view the class happening between a teacher 120 and a plurality of students 130. The classroom 110 may appear filled by means of physical appearance or through holographic imaging.

Further, on visiting the classroom 110, the student S 60 may wish to have a look into a college library 140. The student S 60 navigates to the college library 140 through the student device 80 and an AR device 90 via the centralised platform. Here, there may arise a situation where the student S 60 finds a book 150 interesting and may wish to go through the same. As the student S 60 touches/clicks on the book 150 via the student device 80, the book 150 becomes available to the student S 60 in the virtual environment. For this to happen, the first database which includes the college backup data is synced with the recognition of the touch of the book by the student S 60. Upon analysing the book 150 selected by the student S 60, the system 15 generates a copy of the virtual book and displays the same for the student to visualise the book in the virtual environment.

In the same situation, a person from the library 140 may open a library door in order to exit the library 140. This situation may be happening in physical at the college C 70. The situation is captured by the 360-degree live camera 100b located at the library and the database is updated instantly in real time. The same situation is retrieved by the multimedia retrieving module 30 from the database and is presented on the centralised platform Where the student S 60 is visualising the library 140 through the visualisation module 40. This situation enables both static and dynamic circumstances for visual interaction of the student S 60 in the library 140 of the college C 70.

Further, the student S 60 plans to visit a basketball court 160 in the college C 70, and navigated to the same via the student device 80. It should be noted that a college map, infrastructure and a college map may be captured and pre-stored within the second database associated with the centralised platform. Any further interaction, operations, movements happening within the premises of the college C 70 would be updated dynamically in the second database. Further, as the student S 60 enters the basketball court 160, a virtual basketball 170 would be displayed on a screen of the student device 80 which enables the student to pick the basketball 170 and throws the same into a basketball net 180 within the basketball court 160. However, this situation happens virtually via the student device 80 and the AR device 90. The plurality of images captured by the image capturing devices 100c are made to sync with the movement of the student S 60, thereby generating the virtual experience for the student S 60. Moreover, since the interaction of the student S 60 with the basketball court 160 is achieved by the user interaction module 50 which fetches the visual data from the visualisation module 40 and enable the student S 60 to interact dynamically with the extracted visual data thereby enabling the student S 60 to experience immersive interaction of the user within the college C 70. Upon gaining all the above described experiences, the student S 60 may further decide to enrol with the college C 70.

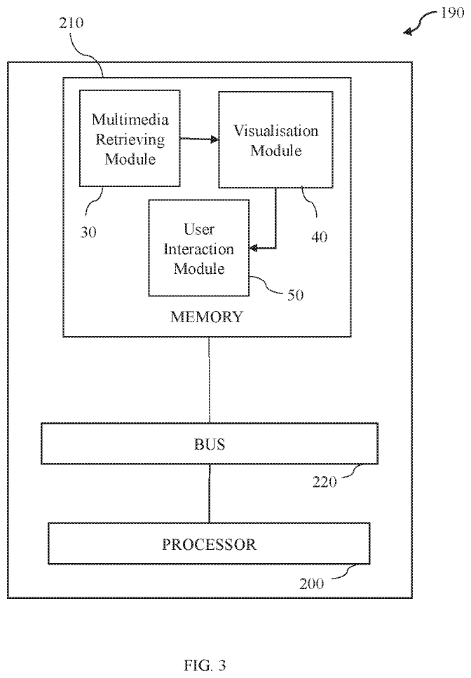

FIG. 3 is a block diagram representation of a processing subsystem located on a local server or on a remote server in accordance with an embodiment of the present disclosure. The server 190 includes processor(s) 200, and memory 210 operatively coupled to the bus 220.

The processor(s) 200, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

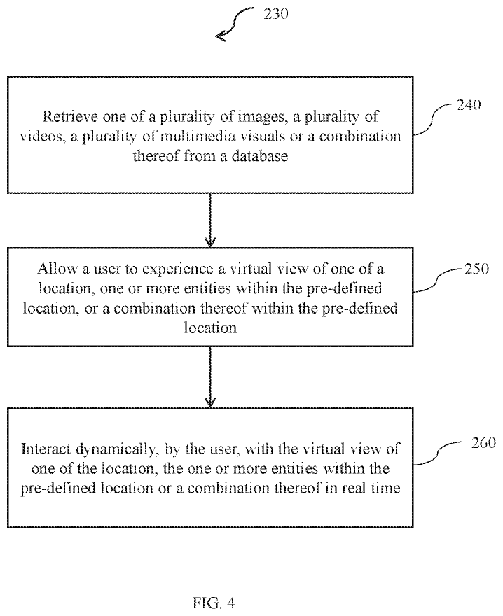

The memory 210 includes a plurality of modules stored in the form of executable program which instructs the processor 200 to perform the method steps illustrated in FIG. 4. The memory 210 is substantially similar to the system 10 of FIG.1. The memory 210 has the following modules: a multimedia retrieving module 30, a visualisation module 40 and a user interaction module 50.

The multimedia retrieving module 30 is configured to retrieve one of a plurality of images, a plurality of videos, a plurality of multimedia visuals or a combination thereof from a database. The visualisation module 40 is configured to allow a user to experience a virtual view of one of a location, one or more entities within the pre-defined location, or a combination thereof within the pre-defined location. The user interaction module 50 is configured to interact dynamically, by the user, with the virtual view of one of the location or the one or more entities within the pre-defined location or a combination thereof in real time.

FIG. 4 is a flow chart representing steps involved in a method 230 for interactive visualisation of a pre-defined location in accordance with an embodiment of the present disclosure. The method 230 includes retrieving one of a plurality of images, a plurality of videos, a plurality of multimedia visuals or a combination thereof from a database in step 240. In one embodiment, retrieving one of the plurality of images, the plurality of videos, the plurality of multimedia visuals may include retrieving one of the plurality of images, the plurality of videos, the plurality of multimedia visuals by a multimedia retrieving module.

In one exemplary embodiment, retrieving one of the plurality of images, the plurality of videos, the plurality of multimedia visuals may include retrieving one of the plurality of images, the plurality of videos, the plurality of multimedia visuals from a database which may be captured by a plurality of image capturing devices. Each of the image capturing devices are positioned at a pre-fixed location within the pre-defined location.

The method 230 also includes allowing a user to experience a virtual view of one of a location, one or more entities within the pre-defined location, or a combination thereof within the pre-defined location using one of a virtual reality technique, an augmented reality technique or a mixed reality technique in step 250. In one embodiment, allowing the user to experience the virtual view may include allowing the user to experience the virtual view by a visualisation module.

Furthermore, the method 230 includes interacting dynamically by the user, with the virtual view of one of the location, the one or more entities within the pre-defined location or a combination thereof in real time for experiencing immersive interaction of the user within the pre-defined location in step 260. In one embodiment, interacting dynamically by the user may include interacting dynamically by the user by a user interaction module.

In one exemplary embodiment, interacting dynamically with the virtual view of one of the location or the one or more entities may include interacting dynamically with the virtual view of one of the location or the one or more entities in real time via at least one user device to experience immersive interaction of the user within the pre-defined location using one of a computing device, a virtual reality device, an augmented reality device, a mixed reality device or a combination thereof.

In one embodiment, experiencing immersive interaction of the user within the pre-defined location may include experiencing immersive interaction of the user within on of an educational institution, a medical organisation, a house, a restaurant, a mall, a monument, a government institution or a private institution.

Various embodiments of the present disclosure enable the system and method for interactive visualisation of a pre-defined location enable the system to provide a platform for the user to interact with the location and the one or more entities within the location dynamically. Since the interaction is dynamic, the system resolves the problem of physically attending the location and physical interaction with the entities within the location. Due to such a solution, the system is highly reliable and saves time of the user and also many as it eliminates the requirement of physical involvement with the location. The system can be scaled or integrated to any environments that requires a digitally engaging experience over AR/VR/MR. also, as the immersive interaction experience of the user with the entities and/or the location is happening in real time due to the live streaming of the plurality of multimedia visuals, the user may not miss out on any of the interaction happening within the location.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for interactive visualisation of a pre-defined location comprising:
one or more processors;
a multimedia retrieving module, operable by the one or more processors, and configured to retrieve one of a plurality of images, a plurality of videos, a plurality of multimedia visuals or a combination thereof from a database, wherein the plurality of images, the plurality of videos and the plurality of multimedia visuals are captured by a plurality of image capturing devices, wherein each of the image capturing devices are positioned at a pre-fixed location within the pre-defined location;
a visualisation module, operable by the one or more processors, and configured to allow a user to experience a virtual view of one of a location, one or more entities within the pre-defined location, or a combination thereof within the pre-defined location using one of a virtual reality technique, an augmented reality technique or a mixed reality technique, wherein the virtual view is representative of the plurality of images, the plurality of videos or the plurality of multimedia visuals retrieved by the multimedia retrieving module; and
a user interaction module operable by the one or more processors, and configured to interact dynamically, by the user, with the virtual view of one of the location or the one or more entities within the pre-defined location or a combination thereof in real time via at least one user device to experience immersive interaction of the user within the pre-defined location.

2. The system as claimed in claim 1, wherein the pre-defined location comprises one of an educational institution, a medical organisation, a house, a restaurant, a mall, a monument, a government institution or a private institution.

3. The system as claimed in claim 1, wherein the plurality of image capturing devices comprises at least one of a still camera, a video camera, a live camera, a 360 degree live camera or a combination thereof.

4. The system as claimed in claim 1, wherein the plurality of images, the plurality of videos and the plurality of multimedia visuals are captured and stored in the database in real-time.

5. The system as claimed in claim 1, wherein the plurality of images, the plurality of videos and the plurality of multimedia visuals are captured and pre-stored in the database.

6. The system as claimed in claim 1, wherein the at least one user device comprises one of a computing device, a virtual reality device, an augmented reality device, a mixed reality device or a combination thereof.

7. A method for interactive visualisation of a pre-defined location comprising:
retrieving, by a multimedia retrieving module, one of a plurality of images, a plurality of videos, a plurality of multimedia visuals or a combination thereof from a database;
allowing, by a visualisation module, a user to experience a virtual view of one of a location, one or more entities within the pre-defined location, or a combination thereof within the pre-defined location using one of a virtual reality technique, an augmented reality technique or a mixed reality technique; and
interacting dynamically, by a user interaction module, by the user, with the virtual view of one of the location, the one or more entities within the pre-defined location or a combination thereof in real time for experiencing immersive interaction of the user within the pre-defined location.

8. The method as claimed in claim 7, wherein retrieving one of the plurality of images, the plurality of videos, the plurality of multimedia visuals comprises retrieving one of the plurality of images, the plurality of videos, the plurality of multimedia visuals captured by a plurality of image capturing devices, wherein each of the image capturing devices are positioned at a pre-fixed location within the pre-defined location.

9. The method as claimed in claim 7, wherein interacting dynamically with the virtual view of one of the location or the one or more entities comprises interacting dynamically with the virtual view of one of the location or the one or more entities in real time via at least one user device to experience immersive interaction of the user within the pre-defined location using one of a computing device, a virtual reality device, an augmented reality device, a mixed reality device or a combination thereof.

10. The method as claimed in claim 7, wherein experiencing immersive interaction of the user within the pre-defined location comprises experiencing immersive interaction of the user within on of an educational institution, a medical organisation, a house, a restaurant, a mall, a monument, a government institution or a private institution.
